(19) United States
(12) Patent Application Publication
(10) Pub. No.: US 2016/0260519 A1
(43) Pub. Date: Sep. 8, 2016

(54) SUSTAINABLE POLY(VINYL HALIDE) MIXTURES FOR THIN-FILM APPLICATIONS

(71) Applicant: POLYONE CORPORATION, Avon Lake, OH (US)

(72) Inventors: Stephen D. HORTON, Avon, OH (US); Craig L. SHOEMAKER, North Ridgeville, OH (US); Alan BARCON, Valley View, OH (US)

(73) Assignee: PolyOne Corporation, Avon Lake, OH (US)

(21) Appl. No.: 15/024,840

(22) PCT Filed: Sep. 23, 2014
(86) PCT No.: PCT/US2014/056941

§ 371 Date: Mar. 24, 2016

Related U.S. Application Data
(60) Provisional application No. 61/882,822, filed on Sep. 26, 2013.

(51) Int. Cl. H01B 3/44; C09D 127/06

(52) U.S. Cl. CPC H01B 3/443; C09D 127/06; C08K 5/1515

(57) ABSTRACT

A mixture of poly(vinyl halide) and epoxidized benzyl fatty acid ester, preferably epoxidized benzyl soyate (EBS), is disclosed. The epoxidized benzyl fatty acid ester as a plasticizer replaces common high molecular weight phthalates, such as diisodecyl phthalate (DIDP), which are conventionally used for the manufacture of wire and cable insulation and jacketing. The epoxidized benzyl fatty acid ester, a bio-plasticizer, unexpectedly outperforms the higher molecular weight DIDP as demonstrated by superior retention of Strain at Break after accelerated aging at elevated temperatures.

### CLAIM OF PRIORITY

This application claims priority from U.S. Provisional Patent Application Ser. No. 61/882,822 bearing Attorney Docket Number 12013037 and filed on Sep. 26, 2013, which is incorporated by reference.

### FIELD OF THE INVENTION

This invention relates to vinyl mixtures, especially flexible poly(vinyl halide) compounds, made using sustainable plasticizers from renewable resources.

### BACKGROUND OF THE INVENTION

All industrial, construction, and consumer products strive to identify raw materials from renewable resources grown or otherwise harvested from the plant or animal kingdom. The expense and increasing scarcity of petrochemically originating raw materials only accentuate the difficulties of recycling after useful life of products made from such raw materials.

The polymer industry, which had started in the early 20^{th} Century with renewable resources such as natural latex for rubber goods, is now returning to such renewable raw materials whenever possible.

A body of research aims for bio-derived plasticizers, as explained in U.S. Pat. No. 6,797,753 (Benecke et al.).

### SUMMARY OF THE INVENTION

Development of synthetic or petrochemical raw materials in the later 20^{th} Century in part occurred because those raw materials performed better. An excellent example of that trend is found in the manufacture of flexible vinyl compounds from certain types of phthalate plasticizers to be used with poly(vinyl chloride) resin (PVC).

Diisodecyl phthalate (DIDP) is a very well known and used phthalate plasticizer for flexible vinyl plastic compounds. A significant source of DIDP is from ExxonMobil Corporation, marketed using the Jayflex™ brand.

What the art needs is a renewable and sustainable plasticizer to replace DIDP and other high molecular weight phthalate ester plasticizers without loss of the performance properties which brought the flexible vinyl compound industry to DIDP originally.

The present invention solves that problem by using epoxidized benzyl fatty acid ester, preferably epoxidized benzyl soyate (EBS) as a plasticizer for PVC mixtures for the manufacture of flexible thin-film vinyl plastic applications, such as wire and cable insulation and wire and cable jacketing.

Unexpectedly, EBS plasticizer in mixture with PVC resin has been found to outperform high molecular weight phthalates such as DIDP in PVC in retention of flexible tensile properties after elevated temperature, accelerated aging tests, even though DIDP is a heavier molecule than EBS and would be expected to outperform EBS according to conventional thinking about the relationship between retained properties and molecular weight.

Therefore, one aspect of the present invention is (a) polyvinyl halide resin and (b) an effective amount of epoxidized benzyl fatty acid ester to provide a greater retention of strain at break for the mixture after heat aging of 168 hours and at least 113° C. than retention of strain at break after heat aging of 168 hours and at least 113° C. of a mixture of the polyvinyl chloride resin and diisodecyl phthalate of the same amount as the effective amount of the epoxidized benzyl fatty acid ester.

Another aspect of the present invention is a thin film made of the mixture described above, wherein the thin film covers at least a portion of a wire or a cable as insulation or jacketing. For purposes of this invention, “thin film” means a film having a thickness of from about 0.001 inch to about 1 inch (0.0025 cm to 2.5 cm) and preferably from about 0.003 inch to about 0.25 inch (0.0075 cm to 0.64 cm).

Another aspect of the present invention is a wire or cable insulation or jacketing described above, wherein the wire or cable is a plenum or riser wire or cable.

Another aspect of the present invention is a wire or cable, comprising a transmission core of optical fiber or metal wire and insulation or jacketing described above.

Another aspect of the present invention is a method of using plasticized poly(vinyl chloride) in wire or cable covering, comprising the steps: (a) mixing epoxidized benzyl fatty acid ester with polyvinyl chloride to form a plasticized polyvinyl chloride; and (b) extruding the plasticized polyvinyl chloride around a transmission core of optical fiber or metal wire to form a wire or cable.

Another aspect of the present invention is a wire or cable, comprising: polyvinyl chloride plasticized with epoxidized benzyl fatty acid ester as a covering.

Additional advantages of the invention are explained in reference to embodiments of the invention.

### EMBODIMENTS OF THE INVENTION

Poly(vinyl halide) Resins

Any poly(vinyl halide) resin is a potential candidate for use in this invention. Predominantly polyvinyl chloride resins are used commercially.

Polyvinyl chloride polymers are widely available throughout the world. Polyvinyl chloride resin as referred to in this invention includes polyvinyl chloride homopolymers, vinyl chloride copolymers, graft copolymers, and vinyl chloride polymers polymerized in the presence of any other polymer such as a HDT distortion temperature enhancing polymer, an impact toughener, a barrier polymer, a chain transfer agent, a stabilizer, and a plasticizer or flow modifier, described in greater detail below.

For example a combination of modifications may be made with the PVC polymer by overpolymerizing a low viscosity, high glass transition temperature (Tg) enhancing agent such as SAN resin, or an imidized polymethacrylate in the presence of a chain transfer agent.

In another alternative, vinyl chloride may be polymerized in the presence of said Tg enhancing agent, the agent having been formed prior to or during the vinyl chloride polymerization. However, only those resins possessing the specified average particle size and degree of friability exhibit the advantages applicable to the practice of the present invention.

In the practice of the invention, there may be used polyvinyl chloride homopolymers or copolymers of polyvinyl chloride comprising one or more comonomers copolymerizable therewith. Suitable comonomers for vinyl chloride include acrylic and methacrylic acids; esters of acrylic and methacrylic acid, wherein the ester portion has from 1 to 12 carbon atoms, for example methyl, ethyl, butyl and ethylhexyl acrylates and the like; methyl, ethyl and butyl methacrylates and the like; hydroxyalkyl esters of acrylic and methacrylic acid, for example hydroxymethyl acrylate, hydroxyethyl acrylate, hydroxyethyl methacrylate and the like; glycidyl esters of acrylic and methacrylic acid, for example glycidyl acrylate, glycidyl methacrylate and the like; alpha, beta unsaturated dicarboxylic acids and their anhydrides, for example maleic acid, fumaric acid, itaconic acid and acid anhydrides of these, and the like; acrylamide and methacrylamide; acrylonitrile and methacrylonitrile; maleimides, for example, N-cyclohexyl maleimide; olefin, for example ethylene, propylene, isobutylene, hexene, and the like; vinylidene chloride, for example, vinylidene chloride; vinyl ester, for example vinyl acetate; vinyl ether, for example methyl vinyl ether, allyl glycidyl ether, n-butyl vinyl ether and the like; crosslinking monomers, for example diallyl phthalate, ethylene glycol dimethacrylate, methylene bis-acrylamide, tracrylyl triazine, divinyl ether, allyl silanes and the like; and including mixtures of any of the above comonomers.

The present invention can also use chlorinated polyvinyl chloride (CPVC), wherein PVC containing approximately 57% chlorine is further reacted with chlorine radicals produced from chlorine gas dispersed in water and irradiated to generate chlorine radicals dissolved in water to produce CPVC, a polymer with a higher glass transition temperature (Tg) and heat distortion temperature. Commercial CPVC typically contains by weight from about 58% to about 70% and preferably from about 63% to about 68% chlorine. CPVC copolymers can be obtained by chlorinating such PVC copolymers using conventional methods such as that described in U.S. Pat. No. 2,996,489, which is incorporated herein by reference. Commercial sources of CPVC include Lubrizol Corporation.

The preferred composition is a polyvinyl chloride homopolymer.

Commercially available sources of polyvinyl chloride polymers include OxyVinyls LP of Dallas, Tex. and Shintech USA of Freeport, Tex.

PVC Compounds

Flexible PVC resin compounds typically contain a variety of additives selected according to the performance requirements of the article produced therefrom well within the understanding of one skilled in the art without the necessity of undue experimentation.

The PVC compounds used herein contain effective amounts of additives ranging from 0.01 to about 500 weight parts per 100 weight parts PVC (parts per hundred resin—phr).

For example, various primary and/or secondary lubricants such as oxidized polyethylene, paraffin wax, fatty acids, and fatty esters and the like can be utilized.

Thermal and ultra-violet light (UV) stabilizers can be utilized such as various organo tins, for example dibutyl tin, dibutyltin-S-S′-bi-(isooctylmercaptoacetate), dibutyl tin dilaurate, dimethyl tin diisooctylthioglycolate, mixed metal stabilizers like Barium Zinc and Calcium Zinc, and lead stabilizers (tri-basic lead sulfate, di-basic lead phthalate, for example). Secondary stabilizers may be included for example a metal salt of phosphoric acid, polyols, and epoxidized oils. Specific examples of salts include water-soluble, alkali metal phosphate salts, disodium hydrogen phosphate, orthophosphates such as mono-, di-, and tri-orthophosphates of said alkali metals, alkali metal polyphosphates, -tetrapolyphosphates and -metaphosphates and the like. Polyols such as sugar alcohols, and epoxides such as epoxidized soybean oil can be used. Typical levels of secondary stabilizers range from about 0.1 wt. parts to about 10.0 wt. parts per 100 wt. parts PVC (phr).

In addition, antioxidants such as phenolics, BPA, BHT, BHA, various hindered phenols and various inhibitors like substituted benzophenones can be utilized.

Various processing aids, fillers, pigments, flame retardants and reinforcing materials can also be utilized in amounts up to about 200 or 300 phr. Exemplary processing aids are acrylic polymers such as poly methyl(meth)acrylate based materials.

Adjustment of melt viscosity can be achieved as well as increasing melt strength by employing 0.5 to 5 phr of commercial acrylic process aids such as those from Rohm and Haas under the Paraloid® trademark. Paraloid®. K-120ND, K-120N, K-175, and other processing aids are disclosed in The Plastics and Rubber Institute: International Conference on PVC Processing, April 26-28 (1983), Paper No. 17.

Examples of fillers include calcium carbonate, clay, silica and various silicates, talc, carbon black and the like. Reinforcing materials include glass fibers, polymer fibers and cellulose fibers. Such fillers are generally added in amounts of from about 3 to about 500 phr of PVC. Preferably from 3 to 300 phr of filler are employed for extruded profiles such as louvers or cove base moldings. Also, flame retardant fillers like ATH (Aluminum trihydrates), AOM (ammonium octamolybdate), antimony trioxides, magnesium oxides and zinc borates are added to boost the flame retardancy of polyvinyl chloride. The concentrations of these fillers range from 1 phr to 200 phr.

Examples of various pigments include titanium dioxide, carbon black and the like. Mixtures of fillers, pigments and/or reinforcing materials also can be used.

The compound of the present invention can include other conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the compounds of the present invention.

Non-limiting examples of other optional additives include adhesion promoters; biocides (antibacterials, fungicides, and mildewcides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Epoxidized Benzyl Fatty Acid Ester Plasticizer

Regardless of the type of thin film application, whether the end product is wire or cable insulation, wire or cable jacketing, or another usage in sheet or film form, the plasticizer is epoxidized benzyl fatty acid ester, a substance which is primarily biologically derived from naturally occurring oils such as canola, corn, linseed, soybean, tall, tallow, algae, etc., and combinations thereof. As discussed above, U.S. Pat. No. 6,797,753 (Benecke et al.), incorporated by reference herein, is an excellent resource to one skilled in the art in understanding the value of using a bio-derived plasticizer with PVC resin. The preferred epoxidized benzyl fatty acid ester, epoxidized benzyl soyate (EBS) is unexpectedly different from the other fatty acid esters discussed in Benecke et al. because it has such properties as good compatibility with PVC, good retention of Strain at Break and other mechanical properties after oven aging, and good (very limited) exudation from PVC.

Stated differently, the EBS plasticizer has greater permanence after Underwriters' Laboratory (UL) heat-aging conditions than petroleum-based plasticizers of similar or greater average molecular weight. This is remarkably surprising, as demonstrated in the results of the Examples below. Therefore, EBS can be used as the primary plasticizer for flexible PVC compounds, in the context that “primary” means the majority or leading plurality plasticizer in the PVC compound. Alternatively, EBS can be used as a secondary plasticizer for flexible PVC compounds, in the context that “secondary” means a minority or lesser plurality plasticizer in the PVC compound than the primary plasticizer.

It should be noted that in reference to the EBS being a primary plasticizer, any residual amount of epoxidized methyl soyate (EMS) in EBS (from 0 to about 10%) is counted as EBS in the relative percentages of plasticizers present in the flexible PVC compound.

EBS in developmental samples is available from PolyOne Corporation. EBS as used in this invention is made according to the disclosure of PCT Patent Application Publication WO2013/059238 “Making Epoxidized Esters from Epoxidized Natural Fats and Oils” (Hagberg et al.) or as disclosed in U.S. Provisional Patent Application 61/763,076 for “Improved Process For Making Certain Epoxidized Fatty Acid Ester Plasticizers” (Howard et al.) filed on Feb. 11, 2013, which applications are incorporated by reference herein.

More particularly, in the improved process, a low moisture epoxidized natural fat or oil is transesterified with a first alcohol in the presence of a transesterification catalyst and under conditions which are effective for carrying out the transesterification reaction, whereby the resultant product mixture phase-separates into an epoxidized fatty acid ester phase and a second phase comprising byproduct glycerol; the byproduct glycerol phase is substantially removed; the epoxidized fatty acid ester phase is combined with more of the first alcohol and with a second alcohol which includes 5 to 7 members in a ring structure in the presence of a transesterification catalyst and under conditions which are effective for forming epoxidized fatty acid esters of the second alcohol; and the first alcohol is continuously removed from the process under reduced pressure conditions as it is displaced by the second alcohol. In preferred embodiments, the epoxidized fatty acid ester phase containing epoxidized fatty acid esters of the first alcohol is used directly and without any intervening refining or purification step in the transesterification with the second alcohol. In certain embodiments, borohydride is added in the first step of the process for providing reduced color materials, or to both of the first and second steps.

In one preferred embodiment of Howard et al. epoxidized soy methyl ester phase from reacting methanol with a low moisture epoxidized soybean oil in the presence of a transesterification catalyst and borohydride, allowing a byproduct glycerol phase to be formed and then removing the byproduct glycerol phase is combined with additional anhydrous methanol, for example, about 0.3 percent by weight of additional anhydrous methanol based on the amount of epoxidized soybean oil starting material, with borohydride and with anhydrous benzyl alcohol in the presence of an alkaline transesterification catalyst. An effective, non-optimized amount of borohydride added in the first and second steps appears for this preferred embodiment to be about 0.3 percent by weight based on the combined reactants and catalyst, though with further optimization of borohydride addition levels we expect it may be found that the borohydride addition for the first step alone will be sufficient, and borohydride addition in the second step omitted if desired.

The alkaline transesterification catalyst can be a sodium methoxide, potassium tert-butoxide or N-heterocyclic carbene catalyst. An example of a commercially available, suitably stable N-carbene catalyst (under air-free conditions) is 1,3-Bis(2,6-diisopropylphenyl)imidazol-2-ylidene (CAS 244187-81-3), from Sigma-Aldrich Co., though other N-carbene catalysts and preparation methods will be within the capabilities of those skilled in the art without undue experimentation. A sodium methoxide catalyst is most preferred.

The reaction is preferably carried out in the presence of the selected catalyst under reduced pressure, with neat reactants insofar as possible, with agitation and in the absence of moisture, with continuous and preferably complete removal of the methanol as the second ester is formed to help drive the reaction toward the desired fatty acid ester plasticizer product.

The alkaline catalyst is then preferably neutralized with acid, for example, with citric acid or phosphoric acid, and the epoxidized unsaturated fatty acid esters of the second alcohols are preferably then washed with water in one more iterations followed by evaporating or stripping away residual water from the washes, adjusting the conditions as necessary to remove any undesired residual alcohol from the second step.

With the use of benzyl alcohol, according to the above-described method, epoxidized benzyl soyate or EBS is produced and is used in this invention.

Other Plasticizers

Vinyl compounds can have other plasticizers because an additional plasticizer might provide other properties desirable during processing or performance. While not preferred in the present invention, it is possible that an additional plasticizer could be any of the bio-derived plasticizers disclosed by Benecke et al. or an organic ester of various acids such as phthalic, trimellitic, phosphoric, adipic, sebacic and the like. Specific examples of useful additional plasticizers include and are not limited to epoxidized soybean oil (ESO), epoxidized linseed oil, epoxidized canola oil, epoxidized corn oil, epoxidized algae oil, epoxidized propylene glycol disoyate, trimellitates such as trioctyl trimellitate, adipates such as dioctyl adipate, sebacates such as dibutyl sebacate, phthalates such as dioctyl phthalate, dinonyl phthalate, and stearates such as glyceryl stearates, and combinations thereof.

Flexible vinyl compounds can range in hardness from about 40 Shore A to about 70 Shore D and preferably from about 60 Shore A to about 60 Shore D, as measured using ASTM 2240 with 15 seconds delay.

Other Optional Additives

A variety of ingredients commonly used in the coatings or plastics compounding industries can also be included in the mixture of the present invention. Non-limiting examples of such optional additives include blowing agents, slip agents, antiblocking agents, antioxidants, ultraviolet light stabilizers, quenchers, plasticizers, mold release agents, lubricants, antistatic agents, flame retardants, and fillers such as glass fibers, talc, chalk, or clay, and combinations thereof

Any conventional colorant useful in coatings and paints or plastics compounding is also acceptable for use in the present invention. Conventional colorants can be employed, including inorganic pigments such as titanium dioxide, iron oxide, chromium oxide, lead chromate, carbon black, silica, talc, china clay, metallic oxides, silicates, chromates, etc., and organic pigments, such as phthalocyanine blue, phthalocyanine green, carbazole violet, anthrapyrimidine yellow, flavanthrone yellow, isoindoline yellow, indanthrone blue, quinacridone violet, perylene reds, diazo red and others.

Table 1 shows the acceptable, desirable, and preferable ranges of amounts, in parts per hundred of resin (PHR), of poly(vinyl halide) resin, epoxidized benzyl fatty acid ester primary plasticizer, and optional additives. The compound can comprise, consist essentially, or consist of these ingredients.

TABLE 1
Formulations

| Ingredient (PHR) | Acceptable | Desirable | Preferable |
|---|---|---|---|
| Poly(vinyl halide) | 100 | 100 | 100 |
| Resin | | | |
| Epoxidized Benzyl | 5-120 | 10-80 | 18-46 |
| Fatty Acid Ester | | | |
| Plasticizer | | | |
| Optional Second | 0-45 | 0-42 | 0-33 |
| Plasticizer | | | |
| Optional Additives | 0-25 | 5-20 | 5-15 |

Processing

Mixing of Poly(vinyl Halide) Resin and Plasticizer for Flexible Vinyl Compound

Conventional mixing equipment is used to thoroughly mix the compound, either in batch or continuous operations.

Mixing in a batch process typically occurs in a compounding fusion mixer (e.g., Henschel mixer, Banbury mixer, twin screw extruder, single screw extruder, co-kneader, and Farrel continuous mixer) operating at a temperature high enough to masticate and fuse the PVC resin, plasticizer, stabilizer, and other ingredients of the flexible vinyl compound. The mixing speeds are typically 10-500 rpm in order to mechanically heat the mixture above the fusing point, about 93° C. (200° F.). The output of the fusion mixer is a powder which then can be placed on a 2 roll mill and heated to 166° C. (330° F.) to melt and fuse the powder into a solid object, such as a strip cut out to press into parts for testing or use. The output from the mixer can also be a solid compound in chips or pellets for later extruding or calendering into a single thin film layer having a thickness useful for insulation or jacketing of wire or cable.

### Usefulness of the Invention

Extruding Techniques

Formation of a wire or cable utilizes conventional techniques known to those having ordinary skill in the art, without undue experimentation. Typically, the core or cores of the wire or cable is/are available along one axis and molten thermoplastic compound is delivered to a specific location using a cross head extrusion die along that axis from an angle ranging from 30 degrees to 150 degrees, with a preference for 90 degrees. Most commonly, the wire is moving along that one axis, in order that delivery of the molten thermoplastic compound to that specific location coats the wire or cable or combination of them or plurality of either or both of them, whereupon cooling forms the insulation or jacket concentrically about the wire or cable.

The most common equipment employed is a subset of extrusion equipment called cross head extrusion which propels the core or cores past an extruder dispensing molten thermoplastic compound at approximately 90° to the axis of the moving wire or cable core or cores undergoing cross head extrusion.

It has been found that compounds of the present invention can be used as “drop in replacements” for conventional wire and cable covering using conventional draw-down ratios and plasticizers such as DIDP.

Compounds of the invention can be extruded as thin films about wire or cable with listing by Underwriters' Laboratories (UL) which performs testing to determine the ratings for wire and cable articles. While articles with a 60° C. or a 75° C. UL rating are useful, there are several types of constructions which require a UL rating of 80° C. or higher ratings (retention of Strain at Break above a minimum amount after168 hours @ 113° C. time and temperature test). Non-limiting examples of them are low voltage power cables like tray cables, building wires with ratings of THW, THHN and THWN, telecommunications cables, apparatus wires and electric cords.

Any elongated material suitable for communicating, transferring or other delivering energy of electrical, optical or other nature is a candidate for the core of the wire or cable of the present invention. Non-limiting examples are metals such as copper or aluminum or silver or combinations of them; ceramics such as glass; and optical grade polymers, such as polycarbonate.

Regardless of the material used as the core to transport energy or signal, the EBS-plasticized poly(vinyl halide) compound then serves as the insulation sleeve or the jacketing cover or both for use in any part of a building or other structure needing electrical power wires or cables or fiber optic communication wires or cables. The UL use temperature is determined by heat aging samples of the jacket or insulation in a forced air oven. After aging the mechanical properties are measured and compared to the original un-aged properties. Usually the retention of Strain at Break must be above 70% for the material to be suitable for use at the rated temperature. For example a material having a UL use temperature rating of 90° C. will be tested in a forced air oven for 168 hours @ 121° C.

The amount of polymer compound used in a wire or cable covering is identified by UL according to UL 444 which correlates the thickness of the covering in relation to the diameter of the cable core.

Table 2 shows the currently published correlation, with the understanding that if the cable is not round, the equivalent diameter should be calculated using 1.1284*(Thickness of the Cable×Width of the Cable)^{1/2}.

TABLE 2

| | Tensile Strength < | | Tensile Strength at Least | |
|---|---|---|---|---|
| | 17.24 MPa (mm) | | 17.24 MPa (mm) | |
| Cable Core | | Min. Ave. | | Min. Ave. |
| Diameter | Min. Ave. | Thickness at | Min. Ave. | Thickness at |
| (mm) | Thickness | Any Point | Thickness | Any Point |
| 0.0-3.3 | 0.33 | 0.25 | 0.33 | 0.25 |
| 3.3-8.89 | 0.58 | 0.46 | 0.33 | 0.25 |
| 8.89-10.16 | 0.69 | 0.56 | 0.46 | 0.36 |
| 10.16-17.78 | 0.81 | 0.66 | 0.46 | 0.36 |
| 17.78-38.10 | 1.14 | 0.91 | 0.76 | 0.61 |
| 38.10-63.50 | 1.52 | 1.22 | 1.14 | 0.91 |
| 63.50-88.90 | 1.91 | 1.52 | 1.52 | 1.22 |

Calendering Techniques

Flexible vinyl sheeting, containing vinyl compound, plasticizer, and optionally other ingredients, is another thin film application. Flexible vinyl sheeting can be used in the formation of flexible industrial curtains. Non-limiting examples of industrial curtain include warehouse entrance curtains, welding curtains, and freezer curtains (including those at retail food stores where frozen food items are on display in open display conditions.)

Further embodiments are described in the following examples.

### EXAMPLES

Table 3 shows the source of the ingredients and the amounts used to prepare Comparative Examples A-B and Examples 1-4. Table 4 shows the testing methods for the test results. Table 5 shows the ingredients and test results. All ingredients were added to a container in no specific order and mixed by hand to form a dry blend. Mastication of the dry blend was then performed using a double roll mill with a processing temperature of 320° F. (160° C.) and a processing time of four minutes (once fully fluxed). Compression molded plaques were then prepared at 350° F. (177° C.), which produced test specimens for the data shown in Table 5.

TABLE 3

| SAP Name | Trade & Chemical Name | Commercial Source |
|---|---|---|
| SUSP RESIN | OxyVinyls PVC suspension | OxyVinyls, Dallas |
| 240F | resin 240F, PVC suspension | TX |
| | resin | |
| NAFTOSAFE | Naftosafe PKP-1152, lead- | Chemson, |
| PKP-1152 | free mixed metal stabilizer | Philadelphia, PA |
| | blend | |
| CALCIUM | Calcium Stearate FG | PMC Biogenix, |
| STEARATE | Powder, calcium stearate | Memphis, TN |
| *CAL-CARB | Atomite, ground calcium | Imerys, Roswell, |
| 3.5NT | carbonate | GA |
| *ALUMINA | 839 Aluminum Trihydroxide, | Almatis, Bauxite, |
| TRIHYDRATE | aluminum hydroxide | AR |
| PRECIPITATED | | |
| *ANTIMONY | Antimony Oxide, antimony | Youngsun & Essen, |
| OXIDE | trioxide | Houston, TX |
| Naftochem | Naftochem CG-581, calcium, | Chemson, |
| CG-581 | zinc, borate flame retardant | Philadelphia, PA |
| EBS | Epoxidized benzyl soyate | PolyOne, Avon |
| | | Lake, OH |
| Plaschek | Plaschek 775, epoxidized | Ferro, Mayfield |
| 775/Drapex | soybean oil | Height, OH |
| 6.8/Viko | | |
| *DIDP ELECT | Jayflex DIDP-E Plasticizer, | ExxonMobil, |
| GR | diisodecyl phthalate - | Houston, TX |
| | electrical grade | |
| SHINTECH | Shintech ™ PVC resin SE | Shintec, Freeport, |
| SE1150 | 1150, PVC suspension resin | TX |
| STEARIC ACID | Hystrene 5016 NF Food | PMC Biogenix, |
| | Grade, steric acid | Memphis, TN |
| Mark 4782 | Mark 4782A barium-zinc | Galata Chemicals, |
| | PVC stabilizer | Hahnville, LA |

TABLE 4
Identification of Physical Tests Shown in Table 5

| | Testing | | | |
|---|---|---|---|---|
| Test Name | Authority | No. | Variations | Units |
| Specific Gravity | ASTM | D792 | | — |
| Durometer Hardness, A, | ASTM | D2240 | Shore A | — |
| Instant | | | | |
| Durometer Hardness, A, 15 | ASTM | D2240 | Shore A | — |
| sec delay | | | | |
| Brittleness of Plastic | ASTM | D746 | 2° C. | ° C. |
| | | | increments | |
| Tensile Strength at Break | ASTM | D638 | type IV | psi |
| Tensile Strength at 100% | ASTM | D638 | type IV | psi |
| Strain | | | | |
| Elongation (Strain at break) | ASTM | D638 | type IV | % |
| Tensile Strength, 10 days at | ASTM | D638 | type IV | psi |
| 100° C. | | | | |
| Tensile Strength at 100% | ASTM | D638 | type IV | psi |
| Strain, 10 days at 100° C. | | | | |
| Elongation (Strain at | ASTM | D638 | type IV | % |
| Break), 10 days at 100° C. | | | | |
| Tensile Strength, 7 days at | ASTM | D638 | type IV | psi |
| 113° C. and at 121° C. | | | | |
| Tensile Strength at 100% | ASTM | D638 | type IV | psi |
| Strain, 7 days at 113° C. and | | | | |
| at 121° C. | | | | |
| Elongation (Strain at | ASTM | D638 | type IV | % |
| Break) 7 days at 113° C. and | | | | |
| at 121° C. | | | | |

TABLE 5

| | Example | | | | | |
|---|---|---|---|---|---|---|
| | A | 1 | 2 | B | 3 | 4 |
| SUSP RESIN 240F | 100.00 | 100.00 | 100.00 | | | |
| NAFTOSAFE PKP-1152 | 4.00 | 4.00 | 4.00 | | | |
| CALCIUM STEARATE | 0.50 | 0.50 | 0.50 | | | |
| *CAL-CARB 3.5NT | 22.50 | 22.50 | 22.50 | | | |
| *ALUMINA TRIHYDRATE | 22.50 | 22.50 | 22.50 | | | |
| PRECIPITATED | | | | | | |
| *ANTIMONY OXIDE | 2.50 | 2.50 | 2.50 | | | |
| Naftochem CG-581 | 2.50 | 2.50 | 2.50 | | | |
| EBS | | 64.00 | 22.40 | | 46.00 | 18.40 |
| Plaschek 775/Drapex 6.8/Viko | | | 41.60 | 5.00 | 5.00 | 32.60 |
| *DIDP ELECT GR | 64.00 | | | 46.00 | | |
| SHINTECH SE1150 | | | | 100.00 | 100.00 | 100.00 |
| STEARIC ACID | | | | 0.50 | 0.50 | 0.50 |
| *MARK 4782 | | | | 2.00 | 2.00 | 2.00 |
| Total PHR: | 218.50 | 218.50 | 218.50 | 153.50 | 153.50 | 153.50 |
| TEST RESULTS | | | | | | |
| Specific Gravity | 1.3828 | 1.3950 | 1.3888 | 1.2276 | 1.2358 | 1.2413 |
| Durometer Hardness, A, Instantaneous | 89.6 | 81.2 | 81.2 | 92.3 | 83.0 | 87.8 |
| Durometer Hardness, A, 15 sec delay | 82.5 | 74.1 | 74.1 | 85.5 | 75.4 | 79.6 |
| Brittleness of Plastic, ° C. | −28.0 | −33.6 | −25.4 | −26.5 | −33.0 | −26.5 |
| Tensile Strength at Break, psi | 2377.4 | 2318.2 | 2451.1 | 2985.075 | 2778.708 | 3092.718 |
| Tensile Strength at 100% Strain, psi | 1409.035 | 1051.492 | 1274.93 | 1709.686 | 1249.153 | 1551.866 |
| Strain at Break, % | 335.331 | 368.515 | 348.701 | 394.910 | 393.976 | 401.691 |
| Weight loss of Original after 10 days at | −3.7% | −3.7% | −1.3% | −2.8% | −3.8% | −1.8% |
| 100° C. | | | | | | |
| Tensile Strength, 10 days at 100° C. (% of | 112.1% | 107.6% | 101.4% | 96.1% | 102.3% | 96.4% |
| Original Tensile Strength Retained) | | | | | | |
| Tensile Strength at 100% Strain, 10 days at | 126.9% | 127.2% | 103.0% | 114.2% | 118.4% | 107.4% |
| 100° C. (% of Original Tensile Strength at | | | | | | |
| 100% Strain Retained) | | | | | | |
| Strain at Break, 10 days at 100° C. (% of | 96.8% | 96.8% | 103.1% | 91.7% | 88.0% | 98.7% |
| Original Strain at Break Retained) | | | | | | |
| Weight loss of Original Sample after 7 days | −5.6% | −4.2% | −1.8% | −8.9% | −6.7% | −3.1% |
| at 113° C. | | | | | | |
| Tensile Strength, 7 days at 113° C. (% of | 105.6% | 111.8% | 102.5% | 104.1% | 106.9% | 98.9% |
| Original Tensile Strength Retained) | | | | | | |
| Tensile Strength at 100% Strain, 7 days at | 144.5% | 147.7% | 114.4% | 164.3% | 150.7% | 114.9% |
| 113° C. (% of Original Tensile Strength at | | | | | | |
| 100% Strain Retained) | | | | | | |
| Strain at Break, 7 days at 113° C. (% of | 69.6% | 92.5% | 99.3% | 67.5% | 83.4% | 96.9% |
| Original Strain at Break Retained) | | | | | | |
| Weight loss of Original after 7 days at 121° C. | −9.6% | −5.9% | −2.6% | −11.8% | −7.3% | −3.4% |
| Tensile Strength, 7 days at 121° C. (% of | 114.0% | 114.8% | 103.8% | 101.5% | 105.4% | 97.8% |
| Original Tensile Strength Retained) | | | | | | |
| Tensile Strength at 100% Strain, 7 days at | 185.8% | 174.8% | 120.4% | 173.5% | 168.9% | 125.5% |
| 121° C. (% of Original Tensile Strength at | | | | | | |
| 100% Strain Retained) | | | | | | |
| Strain at Break, 7 days at 121° C. (% of | 31.3% | 86.0% | 95.8% | 19.2% | 76.5% | 95.5% |
| Original Strain at Break Retained) | | | | | | |

The results in Table 5 showed that, regardless of the type of PVC resin used, the EBS and ESO/EBS Examples 1-4 met or exceeded the performance of the DIDP of Comparative Examples A and B. The amount of EBS present in the compound, compared with ESO in Examples 2-4 demonstrated that EBS could serve as a primary or a secondary plasticizer, preferably as a primary plasticizer (majority or plurality of plasticizer ingredient(s)).

Specifically, hardness, specific gravity and brittleness of plastic results for compounds containing EBS or combinations of EBS and ESO exhibited results are comparable to or better than the DIDP-containing Comparative Examples A and B.

Surprisingly and most unexpectedly, retention of Strain at Break and weight loss results, after oven aging for the compounds of Examples 1 and 3 (containing EBS) at 113° C. and at 121° C. were better than for the compounds of Comparative Examples A and B (containing DIDP). These results are surprising and unexpected because they contradict conventional thinking based on the fact that the average molecular weight of EBS (about 392, or even lower considering any EMS present) is approximately 12% lower than the average molecular weight of DIDP (about 447)

Prior art documentation predicts that a higher molecular weight plasticizer (in this case, DIDP at about 447 Mw) would produce better retention of Strain at Break and lower weight loss results than a lower molecular weight plasticizer (in this case, EBS at about 392 Mw) after oven aging.

The opposite is unexpectedly true for this invention, resulting in better retention of Strain at Break by EBS vs. DIDP despite EBS being about12% lower in molecular weight.

More specifically, the performance of Examples 1-4 at 113° C. or 121° C. and 168 hours (7 days) of aging permit one having ordinary skill in the art to plan for EBS as either a primary plasticizer or a secondary plasticizer to achieve a 80° C. or 90° C. UL rating, respectively, for insulation or jacketing at a thickness of 0.035 inches (0.89 mm—less than the thickness of one U.S. dime ($0.10)) or greater.

Such performance allows for the plasticized polyvinyl halide compounds of this invention to be useful for thin-film applications, such as wire and cable insulation or wire and cable jacketing. The lower volatility and better heat aging performance would allow the use of EBS based jacket and insulation materials to use in thinner applications or in higher temperature rated cables at thicker usage amounts based on the supplied test data.

The Examples containing EBS had lower weight loss values in the UL 80° C. and 90° C. oven aging testing than did the Comparative Examples containing DIDP. Even though DIDP is a heavier molecule and would have been expected, by those having ordinary skill in the art, to have lower weight loss and better retention of Strain at Break than EBS would. The data of Table 5 report conclusively exactly the opposite. The EBS performed better than the DIDP did in the property which matters most, retention of Strain at Break after UL established time and temperature aging. These results were totally unexpected.

Stated another way, the mixture of PVC and an effective amount of epoxidized benzyl fatty acid ester have a greater retention of Strain at Break for the mixture after heat aging of 168 hours and at least 113° C. than retention of Strain at Break after heat aging of 168 hours and at least 113° C. of a mixture of the polyvinyl chloride resin and diisodecyl phthalate of the same amount as the effective amount of the epoxidized benzyl fatty acid ester. Comparing Examples 1 and 2 to Comparative Example A in respect of Strain at Break after 168 hours heated at 113° C., Example 1 has 1.32 times better retention of Strain at Break than Comparative Example A; Example 2 has 1.43 times better retention of Strain at Break. Stated alternatively, Example 1 has at least 30% greater retention of Strain at Break for that test, and Example 2 has more than 40% greater retention of Strain at Break than does a mixture of PVC and DIDP.

Thus, in a direct comparison with a well known conventional plasticizer, the PVC mixture containing epoxidized benzyl fatty acid ester plasticizer has at least 1.3 times greater retention of Strain at Break than DIDP does, in a direct comparison using a standard UL test, even though the epoxidized benzyl fatty acid ester is about 12% lower in molecular weight than DIDP.

The amount of greater retention can be at least 1.15 times greater retention in the direct comparison of epoxidized benzyl fatty acid ester plasticizers as compared with DIDP, desirably at least 1.2 times greater, and preferably at least 1.3 times greater or even at least 1.4 times greater.

Based on these results of percentage retention of Strain at Break, there is no reason not to expect EBS and other epoxidized benzyl fatty acid esters to outperform other conventional plasticizers in the same retention of Strain at Break comparison, such as dioctyl phthalate (DOP), dioctyl terephthalate (DOTP), diisononyl phthalate (DINP), diundecyl phthalate (DUP), ditridecyl phthalate (DTDP), Tris-(2-Ethylhexyl) Trimellitate (TOTM), and Triisononyl Trimellitate (TINTM).

The plasticized poly(vinyl halide) compositions of the present invention can be formulated, it is noted, in all other respects in a conventional manner, including various kinds of additives in addition to the inventive epoxidized benzyl fatty acid ester as a primary plasticizer. For example, a renewably-based secondary plasticizer and thermal stabilizer such as epoxidized soybean oil can be added, or other secondary plasticizers (including petroleum-based plasticizers) or other additives for improving one or more properties of heat stability, lubricity or weathering resistance, as ultraviolet absorbers, fillers, anti-oxidants, anti-static agents, anti-fogging agents, pigments, dyestuffs, crosslinking aids and the like can be incorporated in the compositions.

The epoxidized benzyl ester can also be blended with other primary plasticizers such as dioctylphthalate, other phthalates, citrates, benzoates, trimellitates, and other aliphatic diesters, though preferably the plasticized polyvinyl halide compositions of the present invention will not include any added phthalates and will include substantially only renewably-based or bio-based plasticizers.

The invention is not limited to the above embodiments. The claims follow.

What is claimed is:

1. A mixture comprising:
(a) polyvinyl halide resin and
(b) an effective amount of epoxidized benzyl fatty acid ester to provide a greater retention of Strain at Break for the mixture after heat aging of 168 hours and at least 113° C. than retention of Strain at Break after heat aging of 168 hours and at least 113° C. of a mixture of the polyvinyl chloride resin and diisodecyl phthalate of the same amount as the effective amount of the epoxidized benzyl fatty acid ester.

2. The mixture of claim 1, wherein the greater retention of Strain at Break is at least 1.15 times greater.

3. The mixture of claim 1, wherein the greater retention of Strain at Break is at least 1.3 times greater.

4. The mixture of claim 1, wherein the molecular weight of the epoxidized benzyl fatty acid ester is about 12% less than the molecular weight of diisodecyl phthalate.

5. The mixture of claim 1, wherein the epoxidized benzyl fatty acid ester is a substance primarily biologically derived from naturally occurring oils.

6. The mixture of claim 5, wherein the naturally occurring oils are selected from the group consisting of canola, corn, linseed, soybean, tall, tallow, algae, and combinations thereof.

7. The mixture of claim 1, wherein the epoxidized benzyl fatty acid ester is epoxidized benzyl soyate.

8. The mixture of claim 1, wherein the polyvinyl halide resin is a homopolymer or copolymer of polyvinyl chloride.

9. The mixture of claim 8, wherein the polyvinyl chloride is chlorinated polyvinyl chloride.

10. The mixture of claim 1, wherein the mixture further comprises a second plasticizer selected from the group consisting of epoxidized soybean oil, epoxidized linseed oil, epoxidized canola oil, epoxidized corn oil, epoxidized algae oil, epoxidized propylene glycol disoyate, trimellitates, adipates, sebacates, phthalates, and stearates, and combinations thereof.

11. The mixture of claim 1, wherein the mixture further comprises an additive selected from the group consisting of blowing agents, slip agents, antiblocking agents, antioxidants, colorants, ultraviolet light stabilizers, quenchers, mold release agents, lubricants, antistatic agents, flame retardants, fillers, and combinations thereof.

12. The mixture of claim 1, wherein the epoxidized fatty acid ester plasticizer is present in the mixture from 5 to 120 parts by weight of the polyvinyl halide resin.

13. A thin film formed from the mixture of claim 1.

14. A wire or cable insulation or jacketing formed from the thin film of claim 13.

15. A wire or cable comprising a transmission core of optical fiber or metal wire and an insulation or jacketing of claim 14.

16. A method of using plasticized poly(vinyl chloride) in wire or cable covering, comprising the steps:
(a) mixing epoxidized benzyl fatty acid ester with polyvinyl chloride to form a plasticized polyvinyl chloride; and
(b) extruding the plasticized polyvinyl chloride around a transmission core of optical fiber or metal wire to form a wire or cable.
